(19) United States
(12) Patent Application Publication
(10) Pub. No.: US 2023/0028296 A1
(43) Pub. Date: Jan. 26, 2023

(54) METHODS AND SYSTEMS FOR REDACTION AND DISPLAY OF TOPIC-FILTERED DATA

(71) Applicant: Automated Controversy Detection, Inc., Granby, MA (US)

(72) Inventors: Keen Sung, Framingham, MA (US); Shiri Dori-Hacohen, Granby, MA (US); Julian Lustig-Gonzalez, Amherst, MA (US); JengYu Chou, Stoneham, MA (US)

(21) Appl. No.: 17/872,975

(22) Filed: Jul. 25, 2022

Related U.S. Application Data
(60) Provisional application No. 63/225,861, filed on Jul. 26, 2021.

(51) Int. Cl. G06F 3/0484; H04L 51/063; G06F 3/04817; G06F 40/279

(52) U.S. Cl. CPC G06F 3/0484; H04L 51/063; G06F 3/04817; G06F 40/279

(57) ABSTRACT

A method for generating and displaying an icon associated with a topic in place of filtered content, the icon associated with functionality allowing for displaying of the filtered content, includes applying, by a filtering engine, a topic-based filter to at least a portion of a data stream. The filtering engine directs a first modification to a user interface displaying the at least the portion of the data stream, the modification comprising redacting the at least the portion of the data stream and displaying at least one icon in place of the at least the portion of the data stream, the at least one icon associated with a topic of the at least the portion of the data stream. The filtering engine receives user input via the at least one icon and directs the displaying of the at least the portion of the data stream.

### CROSS-REFERENCE TO RELATED APPLICATIONS

This application claims priority from U.S. Provisional Patent Application No. 63/225,861, filed on Jul. 26, 2021, entitled “Methods and Systems for Redaction and Display of Topic-Filtered Data,” which is hereby incorporated by reference.

### BACKGROUND

The disclosure relates to methods for redaction and display of topic-filtered data. More particularly, the methods and systems described herein relate to functionality for generating and displaying an icon associated with a topic in place of filtered content subsequent to topic-based filtering of a data stream, the icon associated with functionality allowing for displaying of the filtered content.

Data streams may include data of any kind, including, without limitation, content generated on one or more social media platforms. Other examples include computer network data, email data, and other data generated by one or more users or machines for view by one or more other users or machines.

Such data may include content that viewers may perceive as toxic, emotionally triggering, or mentally harmful. Beyond conventional content moderation, many consumers of online data attempt to manually self-censor their content by removing from view (or “blocking”) any content generated by users the individual consumers perceive as generating toxic content. Such attempts, however, may cause users to get caught in “filter bubbles” without the opportunity to view non-toxic content generated by other users or machines.

Conventionally, therefore, systems for viewing streams of data provide functionality for viewing content or for blocking content from display but do not provide any further granularity. Such systems allow users to identify other users whose data content they do or do not wish to view in the data stream but do not, for example, provide technology allowing users to specify by topic what data to display or not display, regardless of which users created the content. Nor do such systems typically allow users to view what type of data is available for display without viewing the data itself or to subsequently view previously blocked data.

Therefore, there is a need for technology to provide improved filtering options for viewers of data streams displaying content generated by other users or machines and for providing options for viewing previously blocked data.

### BRIEF DESCRIPTION

A method for generating and displaying an icon associated with a topic in place of filtered content subsequent to topic-based filtering of a data stream, the icon associated with functionality allowing for displaying of the filtered content, includes applying, by a filtering engine executing on a first computing device, a topic-based filter to at least a portion of a data stream. The method includes directing, by the filtering engine, a first modification to a user interface displaying the at least the portion of the data stream, the modification comprising redacting the at least the portion of the data stream from the user interface and displaying at least one icon in place of the at least the portion of the data stream, the at least one icon associated with a topic of the at least the portion of the data stream. The method includes receiving, by the filtering engine, user input received via the at least one icon, the user input comprising an instruction to display the at least the portion of the data stream. The method includes directing, by the filtering engine, a second modification to the user interface, the modification comprising displaying the at least the portion of the data stream.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a system for redaction and display of topic-filtered data;

FIG. 1B is a block diagram depicting an embodiment of a system for redaction and display of topic-filtered data;

FIG. 2 is a flow diagram depicting an embodiment of a method for redaction and display of topic-filtered data; and

FIGS. 3A-3C are block diagrams depicting embodiments of computers useful in connection with the methods and systems described herein.

### DETAILED DESCRIPTION

The methods and systems described herein may provide functionality for redaction and display of topic-filtered data. The methods and systems described herein provide an automated solution that uses controversy detection and toxicity detection to reduce content that a user may view as “harmful” or “toxic” or even merely “controversial” without completely censoring information available to the user. By optimizing user control and non-self-censoring against filtering out of content based on one or more topics of the content, a user interface provides functionality for filtering out content while retaining the ability to subsequently display the filtered data to users.

Controversy may refer to a measure of how important and contentious a topic is within a certain population. Toxic content may include, by way of example, and without limitation, content such as hate speech, emotionally triggering content, and adversarial content.

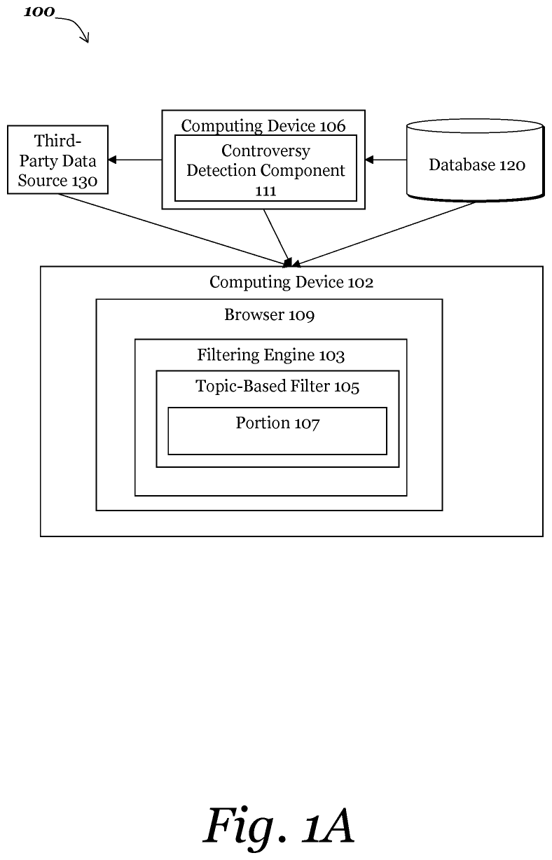

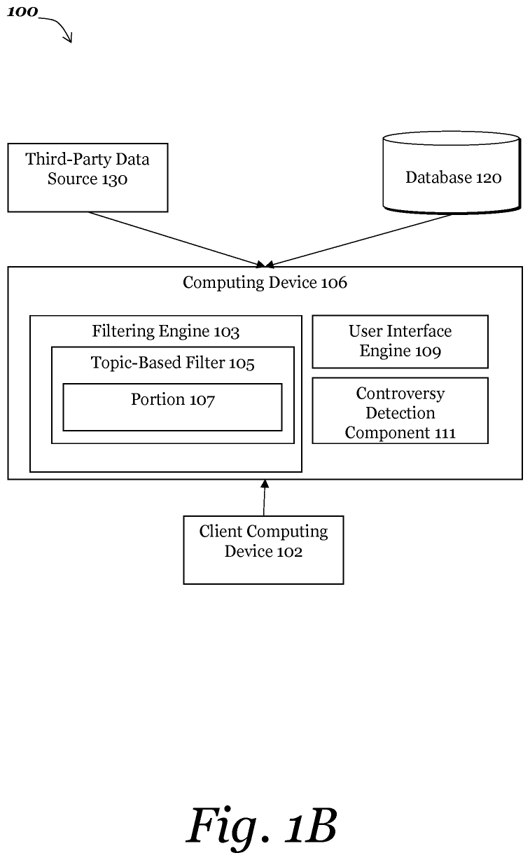

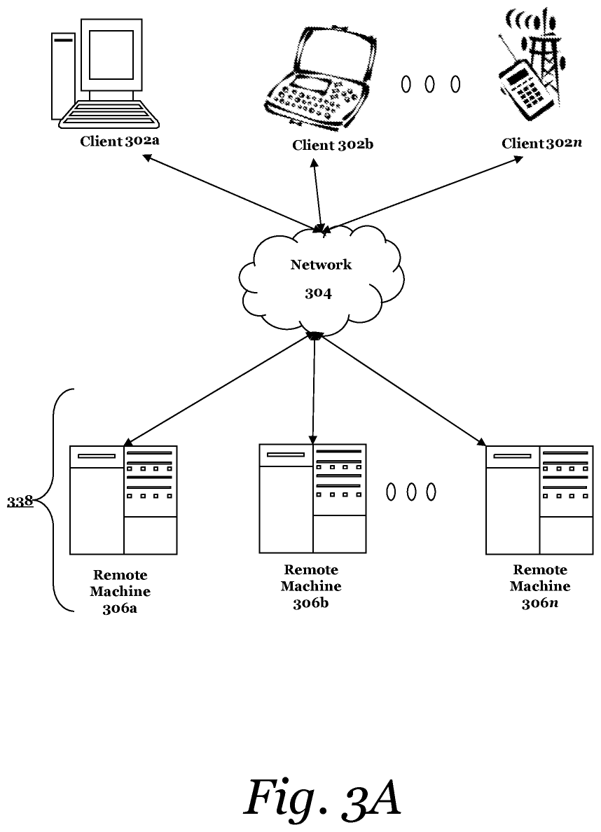

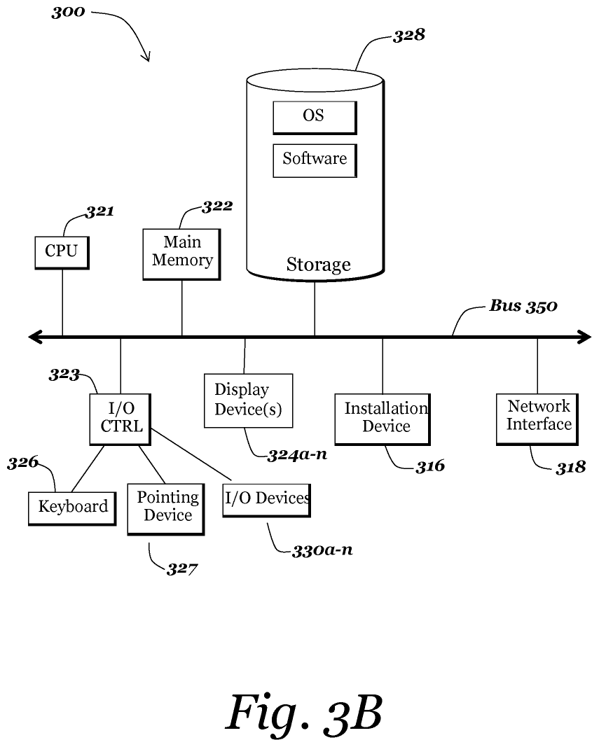

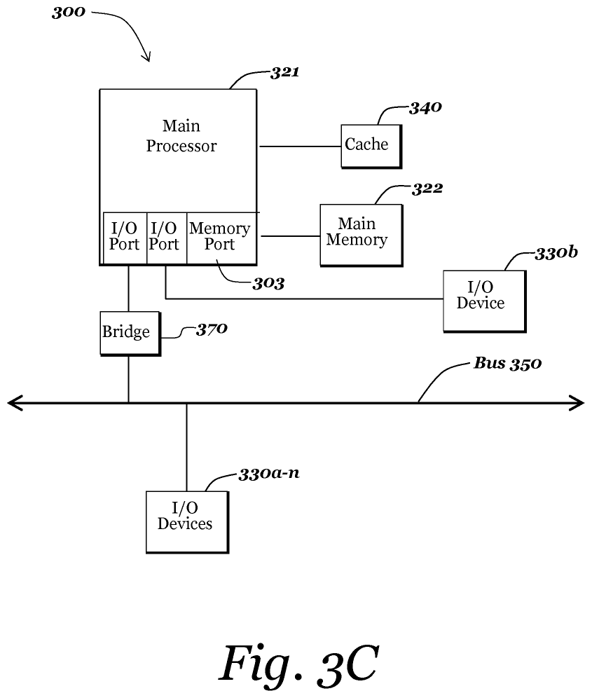

Referring now to FIG. 1A, a block diagram depicts one embodiment of a system 100 for generating and displaying an icon associated with a topic in place of filtered content subsequent to topic-based filtering of a data stream, the icon associated with functionality allowing for displaying of the filtered content. In brief overview, the system 100 includes a computing device 102, a filtering engine 103, a topic-based filter 105, a computing device 106, a portion 107, a user interface engine 109, a controversy detection component 111, a database 120, a third-party data source 130. The computing devices 102 and 106 may be a modified type or form of computing device (as described in greater detail below in connection with FIGS. 3-C) that has been modified to execute instructions for providing the functionality described herein; these modifications may result in a new type of computing device that provides a technical solution to problems rooted in computer technology, such as technology providing improved filtering options for viewers of data streams displaying content generated by other users or machines and for providing options for viewing previously blocked data.

The filtering engine 103 may be provided as a software component. The filtering engine 103 may be provided as a hardware component. As shown in FIG. 1A, a browser 109 may execute the filtering engine 103. The filtering engine 103 may be a client-side component that detects and processes posts from different websites. For example, the filtering engine 103 may be a plug-in or other extension to the browser 109. The filtering engine 103 may include an application programming interface (API) executed to interface with the computing device 102. In other embodiments, the computing device 106 provides the API to interface with the computing device 102. In some embodiments, the filtering engine 103 includes functionality for directly operating on the portion 107.

The filtering engine 103 may be in communication with a server-side controversy detection component 111 that determines a level of toxicity and/or controversy for the portion 107 of data received from the third-party data source 130. The filtering engine 103 may use the determined level to determine whether or not to filter.

The controversy detection component 111 may be provided as a software component. The controversy detection component 111 may be provided as a hardware component. The controversy detection component 111 may execute on a computing device 106 associated with (e.g., maintained by or owned by) an entity making the filtering engine 103 available. The controversy detection component 111 may execute on a computing device 106 associated with (e.g., maintained by or owned by) an entity making the third-party data source 130 available; in such an embodiment, the entity making the filtering engine 103 available may provide the controversy detection component 111 to the entity making the controversy detection component 111 available. The controversy detection component 111 may execute on the computing device 102. The controversy detection component 111 may, in some embodiments, be optional and the filtering engine 103 performs all analysis.

The computing device 106 may contain a server-side filtering engine (not shown). The server-side filtering engine may include a toxicity detection component. The server-side filtering engine may include a misinformation detection component. The server-side filtering engine may include a controversy detection component. The server-side filtering engine may include one or more other analyzers.

The topic-based filter 105 may be provided as a software component. The topic-based filter 105 may be provided as a hardware component. The database 120 may store the topic-based filter 105. The computing device 102 may store the topic-based filter 105. The filtering engine 103 may apply the topic-based filter 105 to a portion 107 of a data stream retrieved directly or indirectly from a third-party data source 130.

The computing device 102 may include or be in communication with the database 120. The computing device 106 may include or be in communication with the database 120. The database 120 may store data related to topic-based filtering of data streams. The database 120 may store filtered data. The database 120 may store topic-based filters. The database 120 may store images to be displayed in place of filtered data. The database 120 may be an ODBC-compliant database. For example, the database 120 may be provided as an ORACLE database, manufactured by Oracle Corporation of Redwood Shores, Calif. In other embodiments, the database 120 can be a Microsoft ACCESS database or a Microsoft SQL server database, manufactured by Microsoft Corporation of Redmond, Wash. In other embodiments, the database 120 can be a SQLite database distributed by Hwaci of Charlotte, N.C., or a PostgreSQL database distributed by The PostgreSQL Global Development Group. In still other embodiments, the database 120 may be a custom-designed database based on an open source database, such as the MYSQL family of freely available database products distributed by Oracle Corporation of Redwood City, Calif. In other embodiments, examples of databases include, without limitation, structured storage (e.g., NoSQL-type databases and BigTable databases), HBase databases distributed by The Apache Software Foundation of Forest Hill, Md., MongoDB databases distributed by ioGen, Inc., of New York, N.Y., an AWS DynamoDB distributed by Amazon Web Services and Cassandra databases distributed by The Apache Software Foundation of Forest Hill, Md. In further embodiments, the database 120 may be any form or type of database.

Referring now to FIG. 1B, a block diagram depicts one embodiment of a system 100 for generating and displaying an icon associated with a topic in place of filtered content subsequent to topic-based filtering of a data stream, the icon associated with functionality allowing for displaying of the filtered content. In brief overview, the system 100 includes a client computing device 102, a computing device 106, a filtering engine 103, a topic-based filter 105, a portion 107, a user interface engine 109, a database 120, and a third-party data source 140. As shown in FIG. 1B, the functionality of the filtering engine 103 that was provided by the browser 109 in FIG. 1A may be executed by an intermediate machine 106 instead. In the embodiment depicted by FIG. 1B, the user interface engine 109, which may be provided as a software component or a hardware component, directs the modification of a user interface displayed to a user of the client computing device 102. The computing device 106 may execute the user interface engine 109. In the embodiment depicted by FIG. 1B, the computing device 102 may include or be in communication with the database 120. By way of example, without limitation, a third-party data source 130 may maintain such an intermediate machine 106 or integrate the intermediate machine 106 into their own systems to provide the filtering functionality.

Although, for ease of discussion, the filtering engine 103, the topic-based filter 105, the user interface engine 109, the controversy detection component 1111, and the database 120 are described in FIG. 1A-B as separate modules, it should be understood that this does not restrict the architecture to a particular implementation. For instance, these components may be encompassed by a single circuit or software function or, alternatively, distributed across a plurality of computing devices.

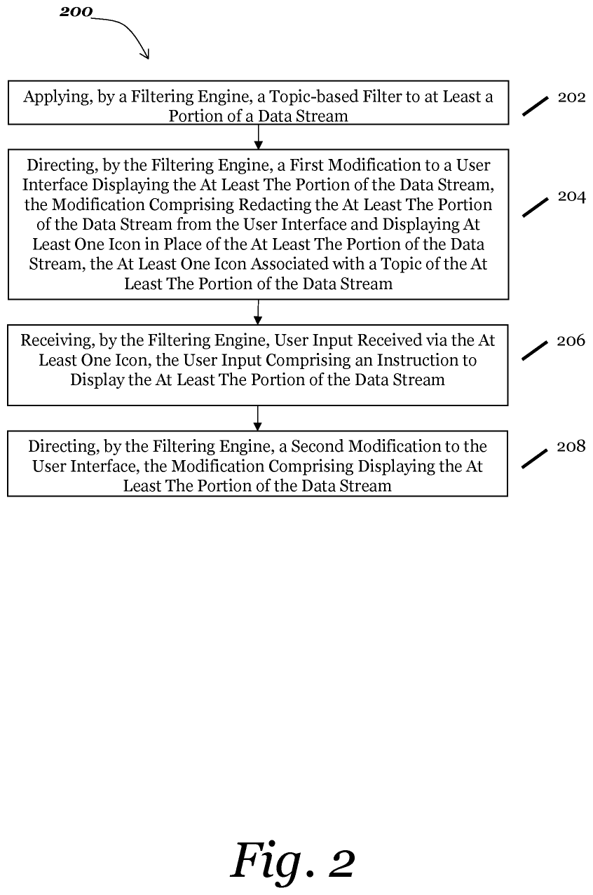

Referring now to FIG. 2, in brief overview, a block diagram depicts one embodiment of a method 200 for generating and displaying an icon associated with a topic in place of filtered content subsequent to topic-based filtering of a data stream, the icon associated with functionality allowing for displaying of the filtered content. The method 200 includes applying, by a filtering engine, a topic-based filter to at least a portion of a data stream (202). The method 200 includes directing, by the filtering engine, a first modification to a user interface displaying the at least the portion of the data stream, the modification comprising redacting the at least the portion of the data stream from the user interface and displaying at least one icon in place of the at least the portion of the data stream, the at least one icon associated with a topic of the at least the portion of the data stream (204). The method 200 includes receiving, by the filtering engine, user input received via the at least one icon, the user input comprising an instruction to display the at least the portion of the data stream (206). The method 200 includes directing, by the filtering engine, a second modification to the user interface, the modification comprising displaying the at least the portion of the data stream (208).

The system 100 may include a user interface allowing users to identify one or more topics to filter. The system 100 may include a user interface allowing users to select whether the filtering engine 103 is to block data entirely or blur the data or apply a different type of redaction. The filtering engine 103 may access the user input received from a user of the computing device 102 prior to filtering any content to determine whether and how the user prefers to have content filtered.

The filtering engine 103 may detect content received from the third-party data source 130. The filtering engine 103 may execute functionality to determine whether there is new data received from the third-party data source 130 for display by the browser 109 and execute a search function upon receiving an indication that there is new data. By way of example, the filtering engine 103 may execute a search function when the filtering engine 103 receives an indication of a modification to data within a Document Object Model (DOM) associated with a web page displayed by the browser 109.

As will be understood by those of ordinary skill in the art, web pages (including those that display email content and/or social media content) may be displayed in the browser 109 as a Document Object Model (DOM). In such web pages, page elements (such as, without limitation, boxes, text fields, image elements, etc.) are a component of the DOM. When there is an infinite scrolling page, which is very common on social media websites for example, the site may use JavaScript to dynamically load elements to the DOM. The filtering engine 103 may execute a JavaScript component to use one or more methods to detect when the DOM has been modified. In one such embodiment, the filtering engine 103 may implement a Mutation Observer which, in turn, calls on the filtering engine 103 to reanalyze the DOM underlying the web page.

The filtering engine 103 may execute a pattern matching component to detect post content and associated metadata.

Referring now to FIG. 2, in greater detail and in connection with FIG. 1, the method 200 includes applying, by a filtering engine, a topic-based filter to at least a portion of a data stream (202). The filtering engine 103 may determine whether the at least the portion of the data stream comprises data having content associated with a topic identified by the topic-based filter.

By applying the topic-based filter 105 to the portion 107 of a data stream received from the third-party data source, the filtering engine 103 may determine whether content in the portion 107 is associated with a topic identified by the filter 105. The filtering engine 103 may execute a keyword-based topic detection analyzer (not shown) to determine whether one or more keywords occur within content in the portion 107. The filtering engine 103 may execute a sentiment analyzer (not shown) to determine whether one or more keywords occur within content in the portion 107. The filtering engine 103 need not apply keyword-based analysis. For example, alternate methods include phrase-based analysis and sentence-based analysis. The filtering engine 103 may combine different types of analyzers in filtering the portion 107; for example, combining an analysis of some or all of the text in the portion 107 with an analysis of a type of sentiment conveyed by the text.

The filtering engine 103 may analyze the portion 107 to determine a level of controversy of content in the portion 107. The filtering engine 103 may analyze the portion 107 to determine a level of toxicity of content in the portion 107. The filtering engine 103 may analyze the portion 107 to determine a level of political polarization of content in the portion 107. The filtering engine 103 may analyze the portion 107 to determine whether the portion 107 includes hate speech. The filtering engine 103 may analyze the portion 107 to determine whether the portion 107 includes one or more emotional triggers. The filtering engine 103 may determine whether content in the portion 107 includes a topic associated with an instruction to redact the content; for example, the filtering engine 103 may have access to an instruction to redact content associated with drinking for users who do not want to view such data.

The filtering engine 103 may analyze one or more words within the portion 107 and determine whether any of the analyzed words is a word or phrase associated with a level of controversy and may then associate the portion 107 with a label identifying the level of controversy. The filtering engine 103 may analyze one or more words within the portion 107 and determine whether any of the analyzed words is a word or phrase associated with a level of toxicity and may then associate the portion 107 with a label identifying the level of toxicity. The filtering engine 103 may analyze one or more words within the portion 107 and determine whether any of the analyzed words is a word or phrase associated with a level of likelihood of triggering an emotional reaction and may then associate the portion 107 with a label identifying the level of likelihood.

The filtering engine 103 may execute one or more filters. The filtering engine 103 may execute one or more analyzers. The computing device 106 may execute one or more filters. The computing device 106 may execute one or more analyzers. The filtering engine 103 and the computing device 106 may each execute different filters or analyzers. The filtering engine 103 and the computing device 106 may each execute the same filters or analyzers. The filtering engine 103 may preserve a level of privacy for the analyzed data (e.g., the content in the portion 107) because the data does not leave the computing device 102. The computing device 106 may provide more computing power and, therefore, faster and/or more sophisticated and/or more powerful analysis than a conventional computing device 102; however, the cost of transmitting data to the server may impact the processing time. In some embodiments, therefore, a hybrid approach is implemented with the filtering engine 103 performing a first analysis and the controversy detection component 111 on a computing device 106 performing a second analysis; this may result, for example, in a basic level of filtering performed on the client computing device 102 and a more sophisticated level of filtering performed on the computing device 106. As an example, and without limitation, the filtering engine 103 may perform basic keyword-based filtering on the frontend (e.g., to identify the word “stupid” within the portion 107) and may escalate the post to be reanalyzed on the computing device 106 (e.g., to determine that the post “these enchiladas are stupid good” is not toxic). Providing both frontend filtering (e.g., on the computing device 102) and backend filtering (e.g., on the computing device 106) may provide users with the option of sending data to the server 106 or not; for example, privacy-seeking users may tick a user interface element that says “Do not send any data back to the server. I understand that this may result in less accurate filtering.”

The filtering engine 103 may transmit a result of applying one or more topic-based filters and/or of executing one or more analyzers to the controversy detection component 111 and receive an identification of a level of controversy associated with the at least the portion of the data stream by the controversy detection component 111. The filtering engine 103 may analyze the received level of controversy to determine whether the received level exceeds a threshold level of controversy associated with an instruction to display data—by way of example, if the level is higher than the threshold level, the filtering engine 103 determines not to allow the browser 109 to display the data. The filtering engine 103 may transmit not just the results of applying the filters and analyzers to the controversy detection component 111 but also the portion 107 (e.g., a social media post or an email or other content along with, optionally, metadata associated with the content). The filtering engine 103 may leverage controversy detection methods that provide labeled data sets. For example, and without limitation, the filtering engine 103 and/or the controversy detection component 111 may leverage a controversy detection method that provides access to a data set (e.g., one or more articles from a Wiki or encyclopedia) with portions of the data set previously labeled as controversial or toxic or both or neither or where the portions of the data set have been associated with a level of controversy or a level of toxicity or both or neither. The filtering engine 103 may use such labels to compare the portion 107 with the previously labeled portion and determine whether the content in the portion 107 has a substantially similar level of controversy or toxicity.

The filtering engine 103 may associate the portion 107 with a label that indicates a topic of content within the portion 107. By way of example, the filtering engine 103 may identify a keyword or phrase associated with a level of controversy that exceeds a threshold level of controversy, the filtering engine 103 may store (locally on the computing device 102 or remotely on, for example, the database 120), the keyword or phrase, the level of controversy, and an indication of whether the filtering engine 103 determined to block, blur, or otherwise redact the content of the portion 107. In such embodiments, a user of the computing device 102 may have authorized such storage by authorizing the filtering engine 103 to store, locally or remotely, the portion 107 and/or to use the portion 107 in improving the execution of the method 200.

The method 200 includes directing, by the filtering engine, a first modification to a user interface displaying the at least the portion of the data stream, the modification comprising redacting the at least the portion of the data stream from the user interface and displaying at least one icon in place of the at least the portion of the data stream, the at least one icon associated with a topic of the at least the portion of the data stream (204). The filtering engine 103 may instruct the browser to redact the at least the portion of the data. The filtering engine 103 may instruct the browser to delete the at least the portion of the data. The filtering engine 103 may instruct the browser to display an image of blurred data in place of the at least the portion of the data. The filtering engine 103 may instruct the browser to display additional content about a topic identified within content in the portion 107. For example, the filtering engine 103 may provide additional context or information about a topic as an expandable element so that the user interface of the page includes a user interface displaying text and user interface elements such as “This topic is particularly polarizing. click here to find out more about the topic, and why users on either side hold particular beliefs.”

The filtering engine 103 includes functionality to modify the DOM underlying or associated with a web page. Therefore, the filtering engine 103 may directly modify the portion 107 by modifying the DOM. For example, the filtering engine 103 may modify the code within the DOM to add a blurring element over the post or to add text or icons (e.g., emojis). The filtering engine 103 may display a user interface upon installation that allows users to configure the browser 109 to authorize the filtering engine 103 to modify the web page and the DOM. Resources for making such modifications (e.g., sample text, icons, emojis, other images, and other types of content) may reside within a local database on the computing device 102 associated with the filtering engine 103.

Byway of example, a setting may indicate that the filtering engine 103 should display an emoji of a green face in place of text in the portion 107 describing an illness or a disease—a user may have determined that viewing data about an illness is triggering or otherwise toxic for them. The user may, for example, want to take a break from viewing statistics on local outbreaks of flu or other viruses and instruct the filtering engine 103 to instead display the emoji of the green face. As another example, a setting may indicate that the filtering engine 103 should display an emoji including a symbol associated with a particular political party or representative of politics in general—in this way, the user views the emoji but not the underlying content.

As an example of how levels of toxicity or controversy may vary by user, for a first user who is struggling with fertility or with an adoption process or who has lost a child or who has a sick child or a child living with disabilities, the filtering engine 103 may replace posts with information about friends' healthy children with an emoji of a baby, allowing the user to know that his or her friends have shared news about the children without requiring the user to review data that may be personally triggering or toxic to that user—however, a second user with a healthy child, or a third user with a sick child or a child living with disabilities, or even the first user at a different point in time, may rely on a social media platform to exchange news and support with other families and not benefit from such filtering.

The filtering engine 103 may provide a user interface with which a user may identify, based on data available within a local database (not shown) of the filtering engine 103, what emojis symbolize for that user and either use one or more default settings or customize the default settings. In some embodiments, the user may create user accounts or associate existing user accounts with the settings in the filtering engine 103 and execute functionality allowing for the sharing of preferences between different browsers on different devices owned by the same user.

The method 200 includes receiving, by the filtering engine, user input received via the at least one icon, the user input comprising an instruction to display the at least the portion of the data stream (206). The browser 109 may provide the filtering engine 103 with an indication that a user hovered a pointing device over the displayed at least one icon. The browser 109 may provide the filtering engine 103 with an indication that a user clicked a pointing device on the displayed at least one icon. The filtering engine 103 may direct the browser 109 to display the previously redacted portion of the data upon receiving the user input.

The method 200 includes directing, by the filtering engine, a second modification to the user interface, the modification comprising displaying the at least the portion of the data stream (208). The filtering engine 103 may modify the DOM to remove the redaction (e.g., the added emoji, blurring effect, or other modification made to remove the content in the portion 107 from view) in the same manner in which it made the initial modification as described above. The modification may be temporary—for example, if a user “hovers” a cursor over a redacted portion 107, the filtering engine may temporarily make the content visible but redact the portion 107 again after the user moves the cursor to a different part of the page. The modification may be persistent—for example, if a user does not subsequently hover over or click on the user interface displayed in place of the redacted content, the filtering engine 103 need not remove the modification that redacted the content in the portion 107.

The filtering engine 103 may repeat the steps above for one or more other portions of the data stream. For example, on a web page displaying social media content or email content where data is periodically updated, the filtering engine 103 may repeat the steps above each time the data is updated.

Therefore, execution of the methods and systems described herein allows the filtering engine 103 to modify a page displaying data to a user such that the user is informed as to a type of data included on the page without having to read or otherwise engage with the data. Unlike conventional systems that may block data entirely or allow users to block other content creators entirely, however, execution of the methods and systems described herein provides customized, per-user modifications to the underlying data to include a symbol of a type of content included in the data and provide the user with the option to temporarily or permanently view the filtered data.

In some embodiments, the system 100 includes non-transitory, computer-readable medium comprising computer program instructions tangibly stored on the non-transitory computer-readable medium, wherein the instructions are executable by at least one processor to perform each of the steps described above in connection with FIG. 2.

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment. However, the scope of protection is defined by the appended claims; the embodiments mentioned herein provide examples.

The terms “A or B”, “at least one of A or/and B”, “at least one of A and B”, “at least one of A or B”, or “one or more of A or/and B” used in the various embodiments of the present disclosure include any and all combinations of words enumerated with it. For example, “A or B”, “at least one of A and B” or “at least one of A or B” may mean (1) including at least one A, (2) including at least one B, (3) including either A or B, or (4) including both at least one A and at least one B.

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be JavaScript, LISP, PROLOG, PERL, C, C++, C#, JAVA, Python, Rust, Go, or any compiled or interpreted programming language.

Each such computer program may be implemented in a computer program product tangibly embodied in a machine-readable storage device for execution by a computer processor. Method steps may be performed by a computer processor executing a program tangibly embodied on a computer-readable medium to perform functions of the methods and systems described herein by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc.

Referring now to FIGS. 3A, 3B, and 3C, block diagrams depict additional detail regarding computing devices that may be modified to execute novel, non-obvious functionality for implementing the methods and systems described above.

Referring now to FIG. 3A, an embodiment of a network environment is depicted. In brief overview, the network environment comprises one or more clients 302a-302n (also generally referred to as local machine(s) 302, client(s) 302, client node(s) 302, client machine(s) 302, client computer(s) 302, client device(s) 302, computing device(s) 302, endpoint(s) 302, or endpoint node(s) 302) in communication with one or more remote machines 306a-306n (also generally referred to as server(s) 306 or computing device(s) 306) via one or more networks 304.

Although FIG. 3A shows a network 304 between the clients 302 and the remote machines 306, the clients 302 and the remote machines 306 may be on the same network 304. The network 304 can be a local area network (LAN), such as a company Intranet, a metropolitan area network (MAN), or a wide area network (WAN), such as the Internet or the World Wide Web. In other embodiments, there are multiple networks 304 between the clients 302 and the remote machines 306. In one of these embodiments, a network 304′ (not shown) may be a private network and a network 304 may be a public network. In another of these embodiments, a network 304 may be a private network and a network 304′ a public network. In still another embodiment, networks 304 and 304′ may both be private networks. In yet another embodiment, networks 304 and 304′ may both be public networks.

The network 304 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, a wireline network, an Ethernet, a virtual private network (VPN), a software-defined network (SDN), a network within the cloud such as AWS VPC (Virtual Private Cloud) network or Azure Virtual Network (VNet), and a RDMA (Remote Direct Memory Access) network. In some embodiments, the network 404 may comprise a wireless link, such as an infrared channel or satellite band. The topology of the network 404 may be a bus, star, or ring network topology. The network 404 may be of any such network topology as known to those ordinarily skilled in the art capable of supporting the operations described herein. The network may comprise mobile telephone networks utilizing any protocol or protocols used to communicate among mobile devices (including tables and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols.

A client 302 and a remote machine 306 (referred to generally as computing devices 300 or as machines 300) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 302 may execute, operate or otherwise provide an application, which can be any type and/or form of software, program, or executable instructions, including, without limitation, any type and/or form of web browser, web-based client, client-server application, an ActiveX control, a JAVA applet, a webserver, a database, an HPC (high-performance computing) application, a data processing application, or any other type and/or form of executable instructions capable of executing on client 302.

In one embodiment, a computing device 306 provides functionality of a web server. The web server may be any type of web server, including web servers that are open-source web servers, web servers that execute proprietary software, and cloud-based web servers where a third party hosts the hardware executing the functionality of the web server. In some embodiments, a web server 406 comprises an open-source web server, such as the APACHE servers maintained by the Apache Software Foundation of Delaware. In other embodiments, the web server executes proprietary software, such as the INTERNET INFORMATION SERVICES products provided by Microsoft Corporation of Redmond, Wash., the ORACLE IPLANET web server products provided by Oracle Corporation of Redwood Shores, Calif., or the ORACLE WEBLOGIC products provided by Oracle Corporation of Redwood Shores, Calif.

In some embodiments, the system may include multiple, logically-grouped remote machines 306. In one of these embodiments, the logical group of remote machines may be referred to as a server farm 338. In another of these embodiments, the server farm 338 may be administered as a single entity.

FIGS. 3B and 3C depict block diagrams of a computing device 300 useful for practicing an embodiment of the client 302 or a remote machine 306. As shown in FIGS. 3B and 3C, each computing device 300 includes a central processing unit 321, and a main memory unit 322. As shown in FIG. 3B, a computing device 300 may include a storage device 328, an installation device 316, a network interface 318, an I/O controller 323, display devices 324a-n, a keyboard 326, a pointing device 327, such as a mouse, and one or more other I/O devices 330a-n. The storage device 328 may include, without limitation, an operating system and software. As shown in FIG. 3C, each computing device 300 may also include additional optional elements, such as a memory port 303, a bridge 370, one or more input/output devices 330a-n (generally referred to using reference numeral 330), and a cache memory 340 in communication with the central processing unit 321.

The central processing unit 321 is any logic circuitry that responds to, and processes instructions fetched from, the main memory unit 322. In many embodiments, the central processing unit 321 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. Other examples include SPARC processors, ARM processors, processors used to build UNIX/LINUX boxes, and processors for mobile devices. The computing device 300 may be based on any of these processors, or any other processor capable of operating as described herein.

Main memory unit 322 may be one or more memory chips capable of storing data and allowing any storage location to be directly accessed by the microprocessor 321. The main memory 322 may be based on any available memory chips capable of operating as described herein. In the embodiment shown in FIG. 3B, the processor 321 communicates with main memory 322 via a system bus 350. FIG. 3C depicts an embodiment of a computing device 300 in which the processor communicates directly with main memory 322 via a memory port 303. FIG. 3C also depicts an embodiment in which the main processor 321 communicates directly with cache memory 340 via a secondary bus, sometimes referred to as a backside bus. In other embodiments, the main processor 321 communicates with cache memory 340 using the system bus 350.

In the embodiment shown in FIG. 3B, the processor 321 communicates with various I/O devices 330 via a local system bus 350. Various buses may be used to connect the central processing unit 321 to any of the I/O devices 330, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 324, the processor 321 may use an Advanced Graphics Port (AGP) to communicate with the display 324. FIG. 3C depicts an embodiment of a computer 300 in which the main processor 321 also communicates directly with an I/O device 330b via, for example, HYPERTRANSPORT, RAPIDIO, or INFINIBAND communications technology.

One or more of a wide variety of I/O devices 330a-n may be present in or connected to the computing device 300, each of which may be of the same or different type and/or form. Input devices include keyboards, mice, trackpads, trackballs, microphones, scanners, cameras, and drawing tablets. Output devices include video displays, speakers, inkjet printers, laser printers, 3D printers, and dye-sublimation printers. The I/O devices may be controlled by an I/O controller 323 as shown in FIG. 3B. Furthermore, an I/O device may also provide storage and/or an installation medium 316 for the computing device 300. In some embodiments, the computing device 300 may provide USB connections (not shown) to receive handheld USB storage devices such as the USB Flash Drive line of devices manufactured by Twintech Industry, Inc. of Los Alamitos, Calif.

Referring still to FIG. 3B, the computing device 300 may support any suitable installation device 316, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. In some embodiments, the computing device 300 may provide functionality for installing software over a network 304. The computing device 300 may further comprise a storage device, such as one or more hard disk drives or redundant arrays of independent disks, for storing an operating system and other software. Alternatively, the computing device 300 may rely on memory chips for storage instead of hard disks.

Furthermore, the computing device 300 may include a network interface 318 to interface to the network 304 through a variety of connections including, but not limited to, standard telephone lines, LAN or WAN links (e.g., 802.11, T1, T3, 56 kb, X.25, SNA, DECNET, RDMA), broadband connections (e.g., ISDN, Frame Relay, ATM, Gigabit Ethernet, Ethernet-over-SONET), wireless connections, virtual private network (VPN) connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 300 communicates with other computing devices 300′ via any type and/or form of gateway or tunneling protocol such as GRE, VXLAN, IPIP, SIT, ip6tnl, VTI and VTI6, IP6GRE, FOU, GUE, GENEVE, ERSPAN, Secure Socket Layer (SSL) or Transport Layer Security (TLS). The network interface 318 may comprise a built-in network adapter, network interface card, PCMCIA network card, card bus network adapter, wireless network adapter, USB network adapter, modem, or any other device suitable for interfacing the computing device 300 to any type of network capable of communication and performing the operations described herein.

In further embodiments, an I/O device 330 may be a bridge between the system bus 350 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 300 of the sort depicted in FIGS. 43B and 3C typically operates under the control of operating systems, which control scheduling of tasks and access to system resources. The computing device 400 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, WINDOWS 8, WINDOWS VISTA, and WINDOWS 10 all of which are manufactured by Microsoft Corporation of Redmond, Wash.; MAC OS manufactured by Apple Inc. of Cupertino, Calif.; OS/2 manufactured by International Business Machines of Armonk, N.Y.; Red Hat Enterprise Linux, a Linux-variant operating system distributed by Red Hat, Inc., of Raleigh, N.C.; Ubuntu, a freely-available operating system distributed by Canonical Ltd. of London, England; CentOS, a freely-available operating system distributed by the centos.org community; SUSE Linux, a freely-available operating system distributed by SUSE, or any type and/or form of a Unix operating system, among others.

Having described certain embodiments of methods and systems for redaction and display of topic-filtered data, it will be apparent to one of skill in the art that other embodiments incorporating the concepts of the disclosure may be used. Therefore, the disclosure should not be limited to certain embodiments, but rather should only be limited by the spirit and scope of the following claims.

What is claimed is:

1. A method for generating and displaying an icon associated with a topic in place of filtered content subsequent to topic-based filtering of a data stream, the icon associated with functionality allowing for displaying of the filtered content, the method comprising:
(a) applying, by a filtering engine executing on a first computing device, a topic-based filter to at least a portion of a data stream;
(b) directing, by the filtering engine, a first modification to a user interface displaying the at least the portion of the data stream, the modification comprising redacting the at least the portion of the data stream from the user interface and displaying at least one icon in place of the at least the portion of the data stream, the at least one icon associated with a topic of the at least the portion of the data stream;
(c) receiving, by the filtering engine, user input received via the at least one icon, the user input comprising an instruction to display the at least the portion of the data stream; and
(d) directing, by the filtering engine, a second modification to the user interface, the modification comprising displaying the at least the portion of the data stream.

2. The method of claim 1 further comprising, before (b) and after (a):
transmitting, by the filtering engine, to a controversy detection engine executing on a second computing device, a result of the application of the topic-based filter;
receiving, by the filtering engine, from the controversy detection engine, an identification of a level of controversy associated with the at least the portion of the data stream; and
determining whether the level of controversy exceeds a threshold level of controversy associated with an instruction to display data.

3. The method of claim 1, wherein (a) further comprises determining, by the filtering engine, whether the at least the portion of the data stream comprises data having content associated with a topic identified by the topic-based filter.

4. The method of claim 1, wherein (a) further comprises executing a keyword-based topic detection analyzer to analyze the at least the portion of the data stream.

5. The method of claim 1, wherein (a) further comprises executing a sentiment analyzer to analyze the at least the portion of the data stream.

6. The method of claim 1, wherein (b) further comprises removing from display the at least one portion of the data stream.

7. The method of claim 1, wherein (b) further comprises blurring a display of the at least one portion of the data stream.

8. The method of claim 1 further comprising repeating (a), (b), and (c) for one or more portions of the data stream.
